(19) United States
(12) Patent Application Publication
(10) Pub. No.: US 2014/0250017 A1
(43) Pub. Date: Sep. 4, 2014

(54) METHODS FOR SECURE TRANSMISSION OF SENSITIVE DATA AND DEVICES THEREOF

(71) Applicant: Infosys Limited, Bangalore (IN)

(72) Inventors: Sameer Mohamed Khan, Trivadrum (IN); Manesh Sadasivan, Kottayam (IN); Koshy Kottoorazhikathu Varghese, Mulavana (IN)

(73) Assignee: Infosys Limited, Bangalore (IN)

(21) Appl. No.: 14/195,996

(22) Filed: Mar. 4, 2014

(30) Foreign Application Priority Data
Mar. 4, 2013 (IN) 917/CHE/2013

(51) Int. Cl. G06Q 20/38

(52) U.S. Cl. CPC G06Q 20/3829
USPC 705/71

(57) ABSTRACT

A method, non-transitory computer readable medium and transaction management device comprising receiving data encrypted using a public asymmetric key and a symmetric key from a mobile computing device, wherein the public asymmetric key and the symmetric key is shared between the transaction management device and the mobile computing device prior to receiving the data. The received data is decrypted using the received symmetric key and an asymmetric private key, wherein the asymmetric private key is generated by the transaction management device prior to receiving the data. One or more actions are performed on the decrypted data

This application claims the benefit of Indian Patent Application Filing Number 917/CHE/2013, filed on Mar. 4, 2013, which is hereby incorporated by reference in its entirety.

### FIELD

This technology generally relates to data security, more particularly, to methods for encrypting data and secure transmission of data and devices thereof.

### BACKGROUND

A point of sale (POS) or point of purchase (POP) is the location where a transaction occurs. Typically, a POS terminal, such as an electronic cash register, is used to complete the POS or POP. With the advancement in mobile technologies, many new changes to optimize POS or POP at a terminal or other register have been proposed. Unfortunately, even though many new approaches for POS systems are emerging, these approaches are not considering either options or the need for higher levels of security posed by this new point of sale dynamic.

For example, current guidelines do not mandate any stringent application level security other than encryption of the transmission media. Accordingly, HTTS based interfaces between a handheld computing device and in-store server components are merely designed to ensure that card data is secure during transmission. As a result, with these new types of POS emerging, higher levels of security to protect this sensitive transaction POS data are needed.

### SUMMARY

This exemplary technology relates to communication between a transaction management device and a mobile computing device for secure transmission of sensitive data. With this technology, sensitive data is encrypted and decrypted using a public asymmetric key and a private symmetric key by the transaction management device and the mobile computing device.

A method for managing sensitive data includes a transaction management device receiving data encrypted using a public asymmetric key and a symmetric key from a mobile computing device, wherein the public asymmetric key and the symmetric key is shared between the transaction management device and the mobile computing device prior to receiving the data. The received data is decrypted by the transaction management device using the received symmetric key and an asymmetric private key, wherein the asymmetric private key is generated by the transaction management device prior to receiving the data. The transaction management device performs one or more actions on the decrypted data.

A non-transitory computer readable medium having stored thereon instructions for managing sensitive data includes receiving data encrypted using a public asymmetric key and a symmetric key from a mobile computing device, wherein the public asymmetric key and the symmetric key is shared between the transaction management device and the mobile computing device prior to receiving the data. The received data is decrypted using the received symmetric key and an asymmetric private key, wherein the asymmetric private key is generated by the transaction management device prior to receiving the data. One or more actions are performed on the decrypted data.

A transaction management device comprising at least one of configurable hardware logic configured to be capable of implementing or a processor coupled to a memory and configured to execute programmed instructions stored in the memory including receiving data encrypted using a public asymmetric key and a symmetric key from a mobile computing device, wherein the public asymmetric key and the symmetric key is shared between the transaction management device and the mobile computing device prior to receiving the data. The received data is decrypted using the received symmetric key and an asymmetric private key, wherein the asymmetric private key is generated by the transaction management device prior to receiving the data. One or more actions are performed on the decrypted data.

A method for encrypting data includes a mobile computing device receiving an encrypted data from a card reader. The encrypted data is further encrypted by the mobile computing device using a public asymmetric key and a symmetric key. The mobile computing device sends the encrypted data to the transaction management device for authorization.

A non-transitory computer readable medium having stored thereon instructions for receiving an encrypted data from a card reader. The encrypted data is encrypted using a public asymmetric key and a symmetric key. The encrypted data is sent to the transaction management device for authorization.

A mobile computing device comprising at least one of configurable hardware logic configured to be capable of implementing or a processor coupled to a memory and configured to execute programmed instructions stored in the memory including receiving an encrypted data from a card reader. The encrypted data is encrypted using a public asymmetric key and a symmetric key. The encrypted data is sent to the transaction management device for authorization.

This technology provides a number of advantages including providing more effective and secures methods, non-transitory computer readable medium and devices for utilizing wireless/handheld devices to perform point of service payment operations. This technology can be easily deployed and scaled allowing for rapid utilization.

### BRIEF DESCRIPTION OF THE DRAWINGS

FIG. 1 is an exemplary network environment which comprises a transaction management device for sensitive data transmission;

FIG. 2 is a flowchart of an exemplary method performed by the transaction management device to transmit sensitive data and obtain authorization status;

FIG. 3 is a flowchart of an exemplary method performed by the mobile computing device for encrypting data for authorization; and

FIG. 4 is an illustration of interaction between a mobile computing device and the transaction management device.

### DETAILED DESCRIPTION

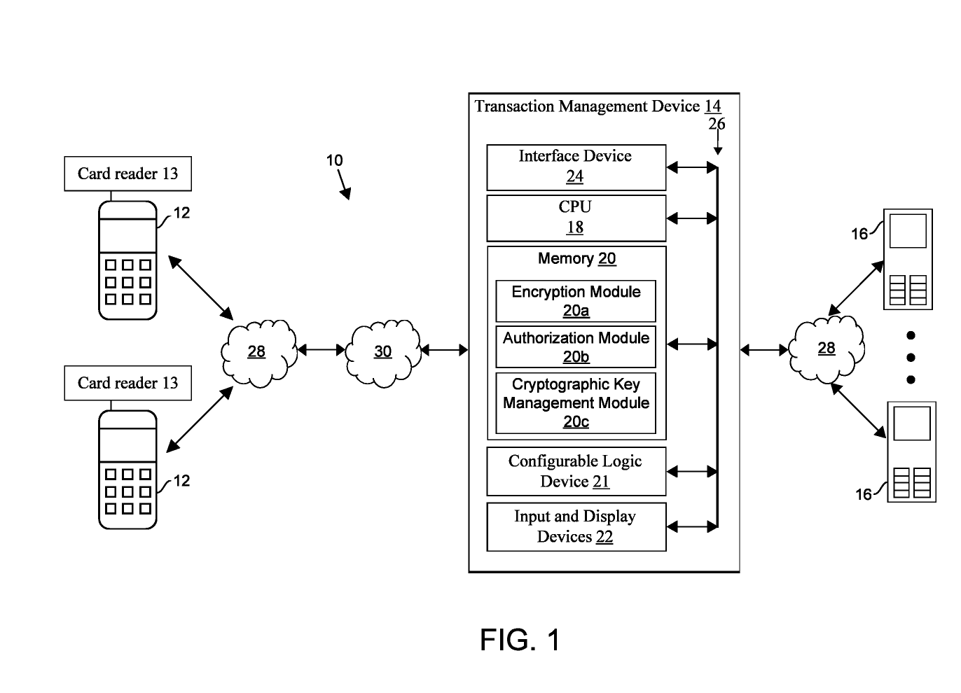

An exemplary environment 10 includes mobile computing device 12 and a transaction management device 14 for encrypting data and secure transmission of encrypted data is illustrated in FIG. 1. The exemplary environment 10 includes mobile computing devices 12, the transaction management device 14 and one or more data servers 16 which are coupled together by the Local Area Network (LAN) 28 and Wide Area Network (WAN) 30, although the environment 10 can include other types and numbers of devices, components, elements and communication networks in other topologies and deployments. Additionally, the mobile computing device 12, transaction management device 14, and one or more data servers 16 can communicate using wireless technologies such as Wi-Fi, 3G or 4G. While not shown, the exemplary environment 10 may include additional components, such as routers, switches and other devices which are well known to those of ordinary skill in the art and thus will not be described here. These technologies provides a number of advantages including providing more effective and secure methods, non-transitory computer readable medium and devices for encrypting data and secure transmission of sensitive encrypted data for authorization purposes.

Referring more specifically to FIG. 1, transaction management device 14 interacts with the mobile computing devices 12 through the LAN 28 and WAN 30 although the transaction management device 14 can interact with the mobile computing devices 12 using any other network topologies. Additionally, the transaction management device 14 can be hosted on a cloud or could be provided as a service.

The transaction management device 14 assists in secure transmission and authorization of data within the environment 10 as illustrated and described with the examples herein, although the transaction management device 14 may perform other types and numbers of functions. The transaction management device 14 includes at least one processor 18, memory 20, optional configurable logic 21, input and display devices 22, and interface device 24 which are coupled together by bus 26, although transaction management device 14 may comprise other types and numbers of elements in other configurations.

Processor(s) 18 may execute one or more computer-executable instructions stored in the memory 20 for the methods illustrated and described with reference to the examples herein, although the processor(s) can execute other types and numbers of instructions and perform other types and numbers of operations. The processor(s) 18 may comprise one or more central processing units (“CPUs”) or general purpose processors with one or more processing cores, such as AMD® processor(s), although other types of processor(s) could be used (e.g., Intel®).

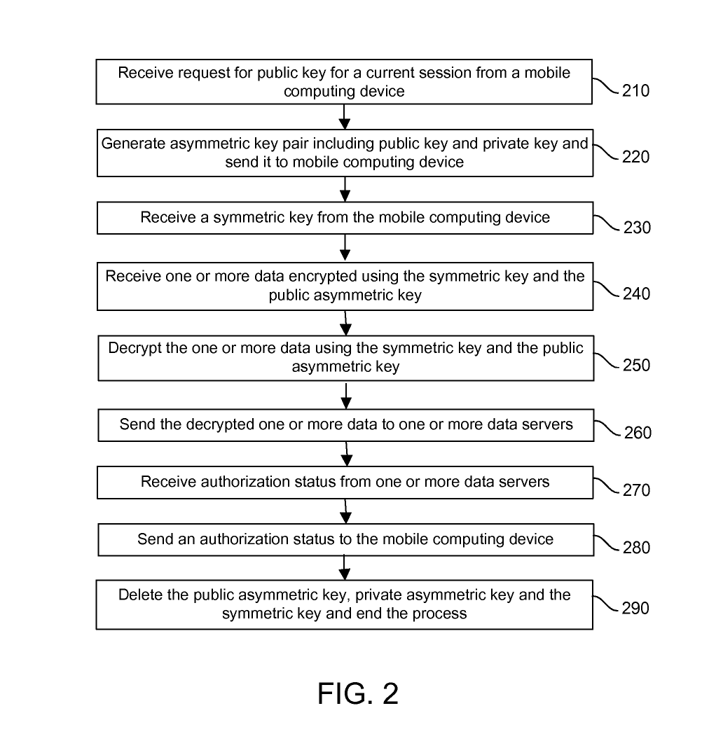

Memory 20 may comprise one or more tangible storage media, such as RAM, ROM, flash memory, CD-ROM, floppy disk, hard disk drive(s), solid state memory, DVD, or any other memory storage types or devices, including combinations thereof, which are known to those of ordinary skill in the art. Memory 20 may store one or more non-transitory computer-readable instructions of this technology as illustrated and described with reference to the examples herein that may be executed by the one or more processor(s) 18. Additionally, memory 20 includes an encryption module 20a, an authorization module 20b, a cryptographic key management module 20c, although the memory 20 may include any additional modules which could assist with encryption and secure transmission of sensitive data. The flow chart shown in FIG. 2-4 is representative of example steps or actions of this technology that may be embodied or expressed as one or more non-transitory computer or machine readable instructions stored in memory 20 that may be executed by the processor(s) 18.

The configurable hardware logic 21 may comprise specialized hardware configured to implement one or more steps of this technology as illustrated and described with reference to the examples herein. By way of example only, the optional configurable hardware logic 21 may comprise one or more of field programmable gate arrays (“FPGAs”), field programmable logic devices (“FPLDs”), application specific integrated circuits (ASICs”) and/or programmable logic units (“PLUs”).

Input and display devices 22 enable a user, such as an administrator, to interact with the transaction management device 14, such as to input and/or view data and/or to configure, program and/or operate it by way of example only. Input devices may include a touch screen, keyboard and/or a computer mouse and display devices may include a computer monitor, although other types and numbers of input devices and display devices could be used. Additionally, the input and display devices 22 can be used by the user, such as an administrator to develop applications using application interface.

The interface device 24 in the transaction management device 14 is used to operatively couple and communicate between the transaction management device 14 and the mobile computing devices 12 which are all coupled together by LAN 28 and WAN 30. By way of example only, the interface device 24 can use TCP/IP over Ethernet and industry-standard protocols, including NFS, CIFS, SOAP, XML, LDAP, and SNMP although other types and numbers of communication protocols can be used. In this example, the bus 26 is a hyper-transport bus, although other bus types and links may be used, such as PCI.

Each of the mobile computing devices 12 includes a central processing unit (CPU) or processor, a memory, an interface device, optional configurable logic and an I/O system, which are coupled together by a bus or other link, although other numbers and types of network devices could be used. Each of the mobile computing device 12 communicate with the transaction management device 14 through LAN 28, although the mobile computing device 12 can interact with the transaction management device 14 by any other means. Additionally, the mobile computing devices 12 includes a hardware device to assist with receiving credit card or a debit card information when a credit/debit card is swiped in the hardware device.

A card reader 13 is communicably coupled with the mobile computing devices 12. The card reader 13 includes a central processing unit (CPU), a memory, optional configurable logic and an I/O system to read the information from a data card such as credit/debit card. The hardware device is a peripheral or an accessory such as a credit/debit card reader attached to the mobile computing device 12, although the card reader 13 can communicate with the mobile computing device 12 without being physically attached.

Each of the one or more data servers 16 includes a central processing unit (CPU) or processor, a memory, an interface device, and an I/O system, which are coupled together by a bus or other link, although other numbers and types of network devices could be used. Generally, the one or more data servers 16 includes one or more credit card information and product information, although other types of information may be present in each of the server 16. A series of applications may run on the servers 16 that allow the transmission of data, such as a data file or metadata, requested by the mobile computing device 12 and the transaction management device 14. It is to be understood that the servers 16 may be hardware or software or may represent a system with multiple servers 16, which may include internal or external networks. In this example the servers 16 may be any version of Microsoft® IIS servers or Apache® servers or mainframes, although other types of servers may be used. Additionally, the one or more data servers 16 can also include data stored in databases which can assist the transaction management device 14 with authorizing encrypted sensitive data.

Although an exemplary environment 10 with the multiple mobile computing devices 12, the transaction management device 14 and the one or more data servers 16 are described and illustrated herein, other types and numbers of systems, devices in other topologies can be used. It is to be understood that the systems of the examples described herein are for exemplary purposes, as many variations of the specific hardware and software used to implement the examples are possible, as will be appreciated by those skilled in the relevant art(s).

Furthermore, each of the systems of the examples may be conveniently implemented using one or more general purpose computer systems, microprocessors, digital signal processors, and micro-controllers, programmed according to the teachings of the examples, as described and illustrated herein, and as will be appreciated by those of ordinary skill in the art.

The examples may also be embodied as a non-transitory computer readable medium having instructions stored thereon for one or more aspects of the technology as described and illustrated by way of the examples herein, which when executed by a processor (or configurable hardware), cause the processor to carry out the steps necessary to implement the methods of the examples, as described and illustrated herein.

An exemplary method for encrypting data and authorizing encrypted data will now be described with reference to FIGS. 1-4. In step 210, the transaction management device 14 receives a request to initiate a session for a transaction from a mobile computing device 12. The received request contains a request to share the asymmetric key for the session, although the received request may contain any additional information such as information relating to the mobile computing device 12. By way of example only, the information relating to the mobile computing device 12 includes unique device number. Additionally, a new public asymmetric key and private asymmetric key is generated by the transaction management device 14 for each new transaction request, although the transaction management device 14 can generate the new public asymmetric key and the private asymmetric key after a certain period of time or after a particular number of sub-transactions within the transaction. By way of example only, the transaction management device 14 can generate the new public asymmetric key and the private asymmetric key after sixty seconds or five sub-transactions within the new transaction. Further, in another example, the transaction management device 14 can generate a hashing pattern identifier along with the generated new public asymmetric key and the new private asymmetric key, although the transaction management device 14 can only generate the hashing pattern identifier.

In step 220, the transaction management device 14 generates a public asymmetric key and a private asymmetric key for the new session using the encryption module 20a. By way of example only, the public asymmetric key and the private asymmetric key generated are in a 1024 bit key using the RSA algorithm which is herein incorporated by reference in its entirety, although the public asymmetric key and the private asymmetric key can be generated in any other format and means. In another example, the transaction management device 14 may also send the generated hashing pattern identifier along with the generated asymmetric key, although the transaction management device 14 can only send the generated hashing pattern identifier. Further, the transaction management device 14 sends the generated public asymmetric key to the requesting mobile computing device 12 and does not send the private asymmetric key with the requesting mobile computing device.

In step 230, the cryptographic key management module 20c present within the transaction management device 14 receives a symmetric key from the requesting mobile device 12 in response to sending the public asymmetric key using the, although the transaction management device 14 may receive any additional information from the requesting mobile computing device 12. The cryptographic key management module 20c present within the transaction management device 14 assists with receiving the symmetric key from the requesting computing device 12, although the cryptographic key management module 20c can assist by performing any additional functions. By way of example only, the symmetric key received by the transaction management device is in an AES-256 bit format, although the symmetric key can be in any other format or can be generated in another other means.

In step 240, the transaction management device 14 receives data from the requesting mobile computing device 12. The data received by the transaction management device 14 is in an encrypted format where the data is encrypted using public asymmetric key generated and sent in step 220 and the symmetric key received in step 230 by the requesting mobile computing device 12. Optionally, the received data may also be encrypted using the card reader 13. By way of example only, the data includes credit card information such as credit card number, name, expiry date, and security code although the data may include any other information relating to a transaction. Additionally, the data may also include sensitive data such as card track data. The transaction management device 14 can also receive any other types and amounts of data in the encrypted format.

In step 250, the transaction management device 14 decrypts the data received in step 240 using the private asymmetric key generated in step 220 and the symmetric key received in step 230, although the transaction management device 14 can decrypt the data using any other method. In another example, the transaction management device 14 decrypts using the received unique identifier of the mobile computing device 12, although the transaction management device 14 can decrypt using the combination of the private asymmetric key, the symmetric key and the unique identifier of the mobile computing device 12.

In step 260, the transaction management device 14 performs one or more actions on the decrypted data by sending the decrypted data to one or more data servers 16 for authorization using the authorization module 20b. The data can be authorized by one of the one or more data servers 16 by comparing the received data with the existing data present in the memory of the one or more data servers 16, although the one or more data servers 16 can authorize the data using any other methods. Optionally, the transaction management device 14 can send the decrypted data to any other databases for present within the environment 10 or outside environment 10 to perform one or more actions on the decrypted data. By way of example only, the decrypted data can be stored at a central database for future reference or can be used to update information stored in other databases, although any other actions can be performed on the decrypted data.

In step 270, the transaction management device 14 receives an authorization status from the one or more data servers 16 using the authorization module 20b. By way of example only, the authorization status received by the transaction management device 14 can be an approved status or a rejected status, although the transaction management device 14 can receive any additional information along with the authorization status.

In step 280, the transaction management device 14 sends the received authorization status to the requesting mobile computing device 12.

In step 290, the transaction management device 14 deletes the public asymmetric key, the private asymmetric key and the symmetric key indicating the end of the transaction and ends the process.

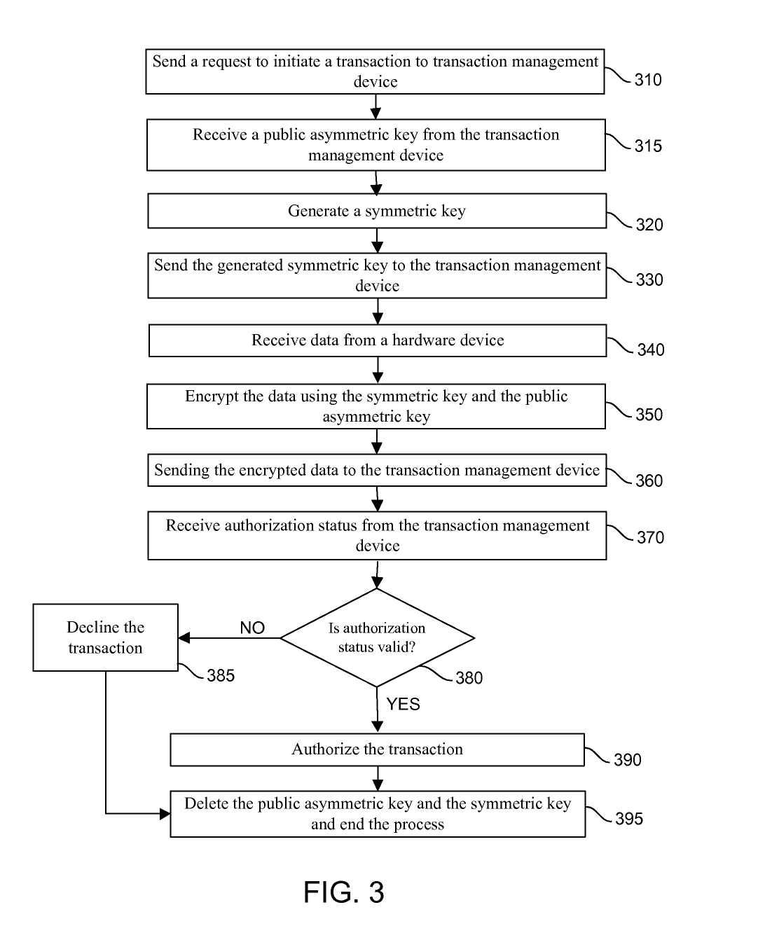

With reference to FIG. 3, in step 310, the mobile computing device 12 sends a request to the transaction management device 14 to indicating initiation of a new transaction immediately upon the completion of the previous transaction. The mobile computing device 12 requests the transaction management device 14 to send an asymmetric public key, although the mobile computing device 12 can request for any additional information. In another example, the mobile computing device 12 can send a unique device identifier associated with the mobile computing device 12 along with the request indicating initiation of the new transaction.

In step 315, the mobile computing device 12 receives the public asymmetric key from the transaction management device 14. The public asymmetric key received by the mobile computing device 12 is in a 1024 bit format generated using a RSA algorithm, although the received public asymmetric key can be in another other format.

In step 320, the mobile computing device 12 generates a symmetric key in response to receiving the public asymmetric key. By way of example only, the symmetric key generated by the mobile computing device 12 is in an AES 256 bit format, although the mobile computing device 12 can generate the symmetric key in any other formats. Additionally, in another example, the mobile computing device 12 can generate a symmetric key using at least a portion of the received public asymmetric key and the unique device identifier number. Further, in another example, the mobile computing device 12 can use the hashing pattern identifier generated in step 210 by the transaction management device 14 along with the received public asymmetric key and the unique device identifier. Additionally, the mobile computing device 14 can generate the symmetric key for each new transaction request, although the mobile computing device 12 can generate the symmetric key after a certain period of time or after a particular number of sub-transactions within the transaction. By way of example only, the mobile computing device 12 can generate the symmetric key after 60 seconds or 5 sub-transactions within the new transaction.

In step 330, the mobile computing device 12 sends the generated symmetric key to the transaction management device 14.

In step 340, the mobile computing device 12 receives data from the card reader 13, wherein the data received from the card reader 13 is for the new transaction. The data received by the mobile computing device 12 is a credit card number, name, expiry date, security code although the data may include any other information such as card track data or any sensitive information relating to a transaction. Additionally, the hardware device may provide any additional level of encryption.

In step 350, the mobile computing device 12 encrypts the data received in step 340 using the symmetric key generated in step 320 and the public asymmetric key received in step 315, although the mobile computing device can encrypt the data using any other methods. Additionally, the data received in step 340 can also be encrypted by the card reader 13 using a pre-determined symmetric key prior to the mobile computing device 12 encrypting the data received using the symmetric key generated in step 330. In another example, the mobile computing device 12 can encrypt the data received in step 340 using the unique device identifier of the mobile computing device 12, although the mobile computing device 12 can encrypt the data received using the symmetric key generated, the public asymmetric key, or the unique device identifier.

In step 360, the mobile computing device 12 sends the encrypted data to the transaction management device 14 for authorizing the transaction. By way of example only, the encrypted data is sent to the transaction management device 14 in a secure communication network such as hyper text transfer protocol secure; although the encrypted data can be sent via any other secure communication networks.

In step 370, the mobile computing device 12 receives an authorization status from the transaction management device 14. By way of example only, the authorization status can be an approved status or a rejected status, although the mobile computing device 12 can receive any additional information.

In step 380, the mobile computing device 12 determines if the authorization status is an approved status or a rejected status. If the mobile computing device 12 determines that the authorization status is an approved status, then a Yes branch is taken to step 390 where the mobile computing device 12 approves the transaction. If the mobile computing device 12 determines that the authorization status is not approved, then a No branch is taken to step 385.

In step 385, the mobile computing device 12 declines the transaction as it received a rejected status from the transaction management device 14.

In step 395, the mobile computing device 12 deletes the public asymmetric key and the symmetric key and ends the process.

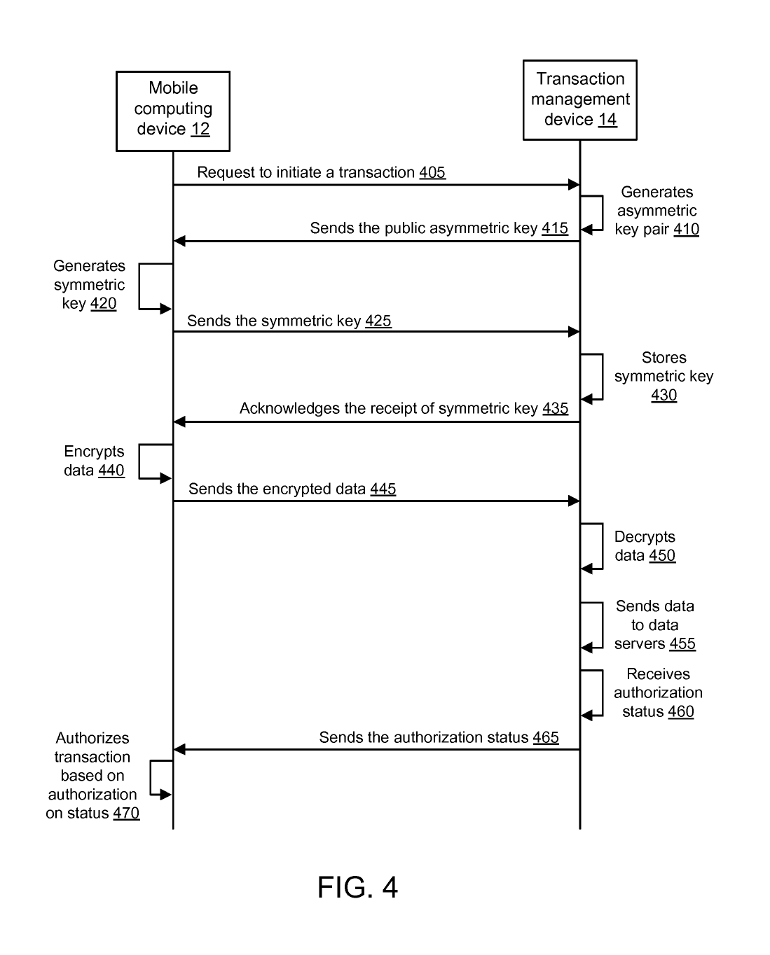

With reference to FIG. 4, in step 405, the mobile computing device 12 after receiving data from a hardware device, initiates a request for a transaction as illustrated in step 340 of FIG. 3.

In step 410, the transaction management device 14 generates an asymmetric key pair including a public asymmetric key and a private asymmetric key as illustrated in step 220 of FIG. 2.

In step 415, the transaction management device sends the generated public asymmetric key to the requesting mobile computing device 12 as illustrated in step 220 of FIG. 2.

In step 420, the mobile computing device 12 generates a symmetric key as illustrated in step 320 of FIG. 3.

In step 425, the mobile computing device 12 sends the generated symmetric key to the transaction management device 14 as illustrated in step 330 of FIG. 3.

In step 430, the transaction management device 14 stores the received symmetric key temporarily in memory 20, although the transaction management device 14 can store the symmetric key at any other locations.

In step 435, the transaction management device 14 sends an acknowledgement indicating the receipt of the symmetric key to the mobile computing device 12.

In step 440, the mobile computing device 12 encrypts the data as illustrated in step 350 of FIG. 3.

In step 445, the mobile computing device 12 sends the encrypted data as illustrated in step 360 of FIG. 3.

In step 450, the transaction management device 14 decrypts the data as illustrated in step 250 of FIG. 2.

In step 455, the transaction management device 14 sends the decrypted data to the one or more data servers 16 as illustrated in step 260 of FIG. 2.

In step 460, the transaction management device 14 receives the authorization status from one or more data servers 16, again as illustrated in step 270 of FIG. 2.

In step 465, the transaction management device 14 sends the authorization status to the requesting mobile computing device 12 as illustrated in step 280 of FIG. 2 and deletes the public asymmetric key, private key and the symmetric key as illustrated in step 290 of FIG. 2.

In step 470, the mobile computing device 12 authorizes the transaction based on the received authorization status as illustrated in steps 380-390 of FIG. 2. After authorizing the transaction, the mobile computing device 12 deletes the public asymmetric key and the symmetric key as illustrated in step 395 of FIG. 3.

This technology provides a number of advantages including providing more effective methods, non-transitory computer readable medium, and devices for utilizing wireless/handheld devices to perform POS payment operations. This technology can be easily deployed and scaled allowing for rapid utilization.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for managing sensitive data comprising:
receiving by a transaction management device data encrypted using a public asymmetric key and a symmetric key from a mobile computing device, wherein the public asymmetric key and the symmetric key is shared between the transaction management device and the mobile computing device prior to receiving the data;
decrypting by the transaction management device the received data using the received symmetric key and an asymmetric private key, wherein the asymmetric private key is generated by the transaction management device prior to receiving the data; and
performing by the transaction management device one or more actions on the decrypted data.

2. The method as set forth in claim 1 wherein the receiving further comprises:
receiving by the transaction management device the symmetric key from the mobile computing device prior to receiving the data; and
storing by the transaction management device the received symmetric key until completion of authorizing the transaction.

3. The method as set forth in claim 1 wherein the public asymmetric key is generated by the transaction management device prior to receiving the data and sent to the requesting mobile computing device.

4. The method as set forth in claim 1 further comprising deleting by the transaction management device the public asymmetric key, the symmetric key and the asymmetric private key after authorizing the transaction.

5. The method as set forth in claim 3 further comprising generating by the transaction management device a new public asymmetric key for each of a new subsequent transaction.

6. The method as set forth in claim 1 wherein the performing one or more actions further comprises:
obtaining by the transaction management device an authorization status from one or more data servers after sending the decrypted data to the one or more data server; and
authorizing by the transaction management device a transaction based on the received authorization status.

7. A non-transitory computer readable medium having stored thereon instructions for managing sensitive data comprising machine executable code which when executed by at least one processor, causes the processor to perform steps comprising:
receiving data encrypted using a public asymmetric key and a symmetric key from a mobile computing device, wherein the public asymmetric key and the symmetric key is shared between a transaction management device and the mobile computing device prior to receiving the data;
decrypting the received data using the received symmetric key and an asymmetric private key, wherein the asymmetric private key is generated by the transaction management device prior to receiving the data; and
performing one or more actions on the decrypted data.

8. The medium as set forth in claim 7 wherein the receiving further comprises:
receiving the symmetric key from the mobile computing device prior to receiving the data; and
storing the received symmetric key until completion of authorizing the transaction.

9. The medium as set forth in claim 7 wherein the public asymmetric key is generated prior to receiving the data and sent to the requesting mobile computing device.

10. The medium as set forth in claim 7 further comprising, deleting the public asymmetric key, the symmetric key and the asymmetric private key after authorizing the transaction.

11. The medium as set forth in claim 9 further comprising generating by the a new public asymmetric key for each of a new subsequent transaction.

12. The medium as set forth in claim 7 wherein the performing one or more actions further comprises:
obtaining an authorization status from data server after sending the decrypted data to the one or more data server; and
authorizing a transaction based on the received authorization status.

13. A transaction management device comprising:
at least one of configurable hardware logic configured to be capable of implementing or a processor coupled to a memory and configured to execute programmed instructions stored in the memory comprising:
receiving data encrypted using a public asymmetric key and a symmetric key from a mobile computing device, wherein the public asymmetric key and the symmetric key is shared between the transaction management device and the mobile computing device prior to receiving the data;
decrypting the received data using the received symmetric key and an asymmetric private key, wherein the asymmetric private key is generated by the transaction management device prior to receiving the data; and
performing one or more actions on the decrypted data.

14. The device as set forth in claim 13 wherein the at least one of configurable hardware logic configured to be capable of implementing or the processor coupled to the memory and configured to execute programmed instructions stored in the memory wherein the receiving further comprises:
receiving the symmetric key from the mobile computing device prior to receiving the data; and
storing the received symmetric key until completion of authorizing the transaction.

15. The device as set forth in claim 13 wherein the at least one of configurable hardware logic configured to be capable of implementing or the processor coupled to the memory and configured to execute programmed instructions stored in the memory wherein the public asymmetric key is generated prior to receiving the data and sent to the requesting mobile computing device.

16. The device as set forth in claim 13 wherein the at least one of configurable hardware logic configured to be capable of implementing or the processor coupled to the memory and configured to execute programmed instructions stored in the memory further comprising deleting the public asymmetric key, the symmetric key and the asymmetric private key after authorizing the transaction.

17. The device as set forth in claim 15 wherein the at least one of configurable hardware logic configured to be capable of implementing or the processor coupled to the memory and configured to execute programmed instructions stored in the memory further comprising generating by the a new public asymmetric key for each of a new subsequent transaction.

18. The device as set forth in claim 13 wherein the at least one of configurable hardware logic configured to be capable of implementing or the processor coupled to the memory and configured to execute programmed instructions stored in the memory wherein the performing one or more actions further comprises:
obtaining an authorization status from one or more data server after sending the decrypted data to the one or more data server; and
authorizing a transaction based on the received authorization status.

19. A method for encrypting data comprising:
receiving by a mobile computing device an encrypted data from a card reader;
encrypting by the mobile computing device the encrypted data using a public asymmetric key and a symmetric key; and
sending by the mobile computing device the encrypted data to a transaction management device for authorization.

20. The method as set forth in claim 19 wherein the encrypting further comprises, receiving by the mobile computing device the public asymmetric key from the transaction management device prior to the encrypting.

21. The method as set forth in claim 19 wherein the symmetric key is generated by the mobile computing device prior to the encrypting.

22. The method as set forth in claim 19 further comprising:
receiving by the mobile computing device an authorization status from the transaction management device based on the sent encrypted data;
authorizing by the mobile computing device a transaction when the received authorization status is an approved status;
declining by the mobile computing device the transaction when the received authorization status is rejected status; and
deleting by the mobile computing device the public asymmetric key and the symmetric key after receiving the authorization status.

23. The method as set forth in claim 19 further comprising generating by the mobile computing device the symmetric key using one or more of at least a part of the received public asymmetric key, a hashing pattern identifier, or a unique device identifier of the mobile computing device.

24. A non-transitory computer readable medium having stored thereon instructions for encrypting data comprising machine executable code which when executed by at least one processor, causes the processor to perform steps comprising:
receiving an encrypted data from a card reader;
encrypting the received data using a public asymmetric key and a symmetric key; and
sending the encrypted data to a transaction management device for authorization.

25. The medium as set forth in claim 24 wherein the encrypting further comprises, receiving the public asymmetric key from the transaction management device prior to the encrypting.

26. The medium as set forth in claim 24 wherein the symmetric key is generated by the mobile computing device prior to the encrypting.

27. The medium as set forth in claim 24 further comprising:
receiving an authorization status from the transaction management device based on the sent encrypted data;
authorizing a transaction when the received authorization status is an approved status;
declining the transaction when the received authorization status is rejected status; and
deleting the public asymmetric key and the symmetric key after receiving the authorization status.

28. The medium as set forth in claim 24 further comprising generating the symmetric key using one or more of at least a part of the received public asymmetric key, a hashing pattern identifier, or a unique device identifier of the mobile computing device.

29. A mobile computing device comprising:
a card reader communicably coupled to a processor and a memory, wherein the card reader is configured to obtain one or more information from a financial data card; and
at least one of configurable hardware logic configured to be capable of implementing or the processor coupled to the memory and configured to execute programmed instructions stored in the memory comprising:
receiving an encrypted data from the card reader;
encrypting the received data using a public asymmetric key and a symmetric key; and
sending the encrypted data to a transaction management device for authorization.

30. The device as set forth in claim 29 wherein the at least one of configurable hardware logic configured to be capable of implementing or the processor coupled to the memory and configured to execute programmed instructions stored in the memory wherein the encrypting further comprises receiving the public asymmetric key from the transaction management device prior to the encrypting.

31. The device as set forth in claim 29 wherein the symmetric key is generated by the mobile computing device prior to the encrypting.

32. The device as set forth in claim 29 wherein the at least one of configurable hardware logic configured to be capable of implementing or the processor coupled to the memory and configured to execute programmed instructions stored in the memory further comprising:
receiving an authorization status from the transaction management device based on the sent encrypted data;
authorizing a transaction when the received authorization status is an approved status;
declining the transaction when the received authorization status is rejected status; and
deleting the public asymmetric key and the symmetric key after receiving the authorization status.

33. The device as set forth in claim 29 wherein the at least one of configurable hardware logic configured to be capable of implementing or the processor coupled to the memory and configured to execute programmed instructions stored in the memory further comprising generating the symmetric key using one or more of at least a part of the received public asymmetric key, a hashing pattern identifier, or a unique device identifier of the mobile computing device.
